(19) United States
(12) Patent Application Publication
(10) Pub. No.: US 2023/0413397 A1
(43) Pub. Date: Dec. 21, 2023

(54) A Microwave Heating Apparatus

(71) Applicants: Sudhir Sanandan, Ahmedabad (IN); Prayas Rokde, Bhopal (IN); Sheldon Savio Napoleon Pinto, Salcetta (IN)

(72) Inventors: Sudhir Sanandan, Ahmedabad (IN); Prayas Rokde, Bhopal (IN); Sheldon Savio Napoleon Pinto, Salcetta (IN)

(21) Appl. No.: 18/029,967

(22) PCT Filed: Oct. 1, 2021
(86) PCT No.: PCT/IB2021/059047

§ 371 Date: Apr. 3, 2023

(30) Foreign Application Priority Data
Oct. 1, 2020 (IN) 202021042681

(51) Int. Cl. H05B 6/64

(52) U.S. Cl. CPC H05B 6/6408; H05B 6/80; H05B 6/6417; H05B 6/647

(57) ABSTRACT

A heating apparatus for multiple modes of heating including microwave heating in combination with other traditional modes of heating is disclosed, having a base; a grill configured with the base and adapted to support a container from a rim of the container holding the container in suspended position; a lid pivotally held with the base for movement between a raised open position and a lowered closed position over the container. At least one microwave generating device is coupled with the lid such that in closed position of the lid, microwave heating using the at least one microwave generating device can be done. A sensing mechanism comprising a plurality of plungers on periphery of the lid is provided such that when the lid is closed over the container, the plungers come in contact with top surface of the rim of the container to detect if the lid is properly closed over the container.

### TECHNICAL FIELD

The present disclosure relates to a heating apparatus that allows heating using multiple sources of heat energy including microwaves. In particular, the present disclosure relates to arrangement that allows efficient use of microwaves.

### BACKGROUND

Background description includes information that may be useful in understanding the present invention. It is not an admission that any of the information provided herein is prior art or relevant to the presently claimed invention, or that any publication specifically or implicitly referenced is prior art.

Heating apparatuses, such as cooking apparatuses, that combine the benefits of both open flame/induction/convection/conduction and other modern microwave cooking into a single apparatus, i.e. allow multiple modes of cooking, are known in the art. For example, one such apparatus is disclosed in the applicant's earlier filed United States Patent application number US20150144006A1 the contents of which, in its entirety, is herein incorporated by reference. The cooking apparatus of the cited Patent document includes: a base; a cooking container configured on the base; and a lid pivotally coupled to the base and configured to cover the cooking container in a lowered position. The lid is coupled with at least one magnetron that acts as a source of microwaves. Covering of the cooking container by the lid enables microwave cooking using the magnetron, whereas the cooking container can also be used for any or a combination of induction, open flame, radiation, convection, and conduction cooking.

Another of applicant's earlier filed patent application number WO2020039280, the contents of which, in its entirety, is herein incorporated by reference, discloses an adaptable cooking apparatus having a lid with at least one microwave producing device coupled with the lid, and a lifting and lowering mechanism carrying the lid and the coupled at least one microwave producing device for vertically raising and lowering the lid and the at least one microwave producing device. An upper end of the lifting and lowering mechanism is configured with a lower side of a chimney. The lid in a lowered position can be operatively coupled with a first container placed over a conventional source of heat, or a second container for preparatory operations comprising any or a combination of blending, stirring, grinding and mixing for simultaneous heating of the contents of the first container or the second container through the microwaves generated by the at least one microwave producing device.

However, the conventional heating apparatus based on coupling of a microwave generating device with a lid for multiple modes of cooking and preparatory operations suffer from drawback in respect of proper engagement of the lid with the containers, i.e. cooking pan or preparatory container. This is because, the containers, being placed on a traditional source of heat, such as gas stove or induction plate, or on top of a kitchen counter, may not be in alignment with the lid leading to the lid not closing properly over the container for efficient working of a choke provided there between, leading to leakage of the microwaves.

There is therefore need in the art for an efficient heating apparatus for multiple modes of cooking that allows efficient microwave cooking without leakage of the microwaves.

### OBJECTS OF THE INVENTION

A general object of the present disclosure is to provide an improved heating apparatus that over comes drawback of the conventional apparatuses for multiple modes of heating and preparations.

An object of the present disclosure is to provide a heating apparatus with a lid configured to align with a top surface of a rim of the container to ensure proper closing of the lid over the container so that leakage of microwaves is prevented.

Another object of the present disclosure is to provide a heating apparatus that aligns the container with the lid irrespective of level of the surface on which the container is placed.

Another object of the present disclosure is to provide a heating apparatus that does not allow the microwave generating device to be switched on unless the lid is properly placed over the container.

Yet another object of the present disclosure is to provide a heating apparatus that includes a sensing mechanism to sense that gap between the lid and the rim of the container.

Still another object of the present disclosure is to provide a heating apparatus that includes a locking mechanism to lock the lid over the container.

Still another object of the present disclosure is to provide a heating apparatus that includes a weight sensing mechanism to sense presence of the container before the apparatus is switched ON.

Yet still another object of the present disclosure is to provide a microwave-based heating apparatus that allows pressure cooking.

Another object of the present disclosure is to provide a heating apparatus that allows App based cooking.

Yet another object of the present disclosure is to provide a heating apparatus that allows spraying of liquids, such as oil and water in the cooking cavity.

Still another object of the present disclosure is to provide a heating apparatus that allows prompt evacuation/sucking of steam from the cooking cavity before opening of the lid.

Yet still another object of the present disclosure is to provide a microwave-based heating apparatus that meets the prevailing certification requirements related to safety of operation.

### SUMMARY

The present disclosure relates to a heating apparatus that allows microwave heating or heating in combination with other modes of cooking/heating, such as open flame heating using gas burners, induction heating using an induction plate or any other similar traditional mode of heating, or during preparatory operations. The proposed heating apparatus allows traditional cooking steps that take place in open flame/induction, and also gives the user an option to switch over to microwave cooking to complete the cooking. In particular, the disclosed heating apparatus overcomes drawback of conventional apparatuses by ensuring that the lid that carries the magnetron for microwave cooking is properly closed over the container before the microwave heating starts, thus ensuring that the microwaves do not leak out, which is a prerequisite for efficient microwave heating.

In an embodiment, the disclosed heating apparatus includes a lid configured for movement between a raised position and a lowered position, and at least one microwave generating device coupled with the lid as a source of microwaves. In the lowered position the lid is configured to cover a container containing items to be heated or cooked thereby enabling microwave heating using the at least one microwave generating device in combination with any of: application of heat to the container from bottom using another heat source and a preparatory operation on contents of the container.

In an aspect, the lid comprises a sensing mechanism to sense proper closing of the container by the lid to ensure that microwaves generated by the at least one microwave generating device do not leak out.

The sensing mechanism can comprise a plurality of retractable plungers provided on periphery of the lid such that when the lid is closed over the container, the plungers come in contact with a seating surface of the container if a gap between the lid and the seating surface of the container is less than a predefined gap value thereby making the gap between the lid and the container generally uniform.

In an aspect, the container consists of a cavity for cooking and a flat seating surface on which the lid consisting of a choke sits over it there by attenuating the power of microwaves going outside, thereby preventing the leakage of microwaves.

The plungers may be biased outward and configured to linearly move inward on coming in contact with the seating surface of the container as the lid is closed over the container.

The plungers may be electrically connected such that the connection is completed when the plungers make contact with the container and wherein all the plungers meet a predefined uniform travel, and wherein the completion of the connection is used as a confirmation that the lid is properly closed over the container.

The heating apparatus may also include a control circuit configured to switch the microwave generating device on only after the connection of the plungers is completed.

The heating apparatus may include a choke mechanism to avoid leakage of microwaves, and wherein the predefined uniform gap value relates to maximum gap allowed between the lid and the seating surface of the container for efficient functioning of the choke.

The heating apparatus may include a locking mechanism to lock the lid after it is closed over the container.

The lid may be pivotally configured with a base for pivotal movement between the raised position and the lowered position. The base may include a conventional source of heat and the container is positioned to receive heat from the conventional source of heat in addition to heating by microwaves generated by the at least one microwave generating device.

The heating apparatus may further include a grill configured with the base to support the container from a rim of the container holding the container in a suspended position. The grill may be configured such that, by holding the container from the rim in suspended position, the grill ensures alignment of the rim of the container with the lid when the lid is lowered over the container.

The lid may be configured with a chimney by a lifting and lowering mechanism for vertical movement between the raised position and the lowered position. The container may be any one of a first container placed over a conventional source of heat, and a second container for preparatory operations comprising any or a combination of blending, stirring, grinding and mixing. Coupling of the lid with the containers enables heating of the contents of the container through the microwaves generated by the at least one microwave producing device.

In a second embodiment, the disclosed heating apparatus includes a base; a grill configured with the base, the grill being configured to support a container from a rim of the container holding the container in a suspended position. The apparatus further includes a lid configured for movement between a raised position and a lowered position in which the lid covers the container. At least one microwave generating device is coupled with the lid as a source of microwaves, such that in the lowered position of the lid, the heating apparatus enables microwave heating using the at least one microwave generating device. The heating apparatus also allows application of heat to the container from bottom using any or a combination of induction, open flame, radiation, convection, and conduction heat source. The grill is configured such that, by holding the container from the rim in suspended position, the grill ensures alignment of the rim of the container with the lid when the lid is lowered over the container.

In an application, the lid may be pivotally held with the base through a self-aligning hinge, which allows movement of the lid so that, in the lowered position of the lid, any tolerance or gaps between the lid and the container is accommodated to ensures the lid and the container are in contact and secure. The grill is configured such that, the pivotal axis of the lid coincides with the pivotal axis of the grill to ensure that, when the lid is closed over the container placed over the grill, they are parallelly aligned, thus ensuring the seating flat surface of container resting on the grill is parallel to the lid when the lid is in the lowered position.

In an alternate application, the lid may be configured with a chimney by a lifting and lowering mechanism for vertical movement between the raised position and the lowered position. The container may be any one of the container placed over grill, and a second container for preparatory operations comprising any or a combination of blending, stirring, grinding and mixing; and wherein coupling of the lid with the containers enables heating of the contents of the containers through the microwaves generated by the at least one microwave producing device.

The lid may include a plurality of retractable plungers provided on periphery of the lid such that when the lid is closed over the container, the plungers come in contact with the rim of the container when a uniform gap between the lid and the rim of the container is less than a predefined uniform gap value.

The plungers may be biased outward and configured to linearly move inward on coming in contact with the rim of the container as the lid is closed over the container.

The plungers may be electrically connected such that the connection is completed when the plungers make contact with the container and wherein all the plungers meet a predefined uniform travel, and wherein the completion of the connection is used as a confirmation that the lid is properly seated over the container.

The heating apparatus may include a control circuit configured to switch the at least one microwave generating device on only after completion of the connection of the plungers.

The heating apparatus may include a choke mechanism to avoid leakage of microwaves, and the predefined uniform gap value may relate to maximum gap allowed between the lid and the rim of the container for efficient functioning of the choke.

The heating apparatus may include a locking mechanism to lock the lid after it is closed over the container. The locking mechanism may include spring loaded balls configured with the lid that lock the lid to the grill. In the locked position the rim of the container may be sandwiched and secured between the grill and the lid.

The grill is configured such that, the pivotal axis of the lid and the pivotal axis of the grill is the same, to ensure they are always parallel aligned, thus ensuring the seating flat surface of container resting on the grill is parallel to the lid when the lid is in the lowered position

The grill may include an adjustable grommet configured at a lower end of a front leg, and configured for an upward and downward adjustment to align the container held in the grill with the lid.

In an alternate arrangement, the grill may include a rear leg configured to rest on the base, the rear leg configured to ensure alignment of the container held in the grill with the lid.

In a third embodiment, the present disclosure provides a heating apparatus having a lid configured for movement between a raised position and a lowered position, wherein in the lowered position the lid is configured to cover a container containing items to be heated or cooked; at least one microwave generating device coupled with the lid as a source of microwaves, such that in the lowered position of the lid, the heating apparatus enables microwave heating using the at least one microwave generating device; and a choke mechanism configured with the lid to avoid leakage of microwaves when the lid is lowered to cover the container. IN an aspect, the choke mechanism is configured to allow the lid to fit tightly over the container so as to build pressure for pressure cooking.

The choke mechanism may include metallic choke fingers, a choke gasket and choke locking members that engage with the container to allow the lid to fit tightly over the container.

The heating apparatus may include an adjustable pressure weight valve configured over the lid to allow steam release.

The heating apparatus may include a secondary pressure safety valve and a fusible safety plug to ensure safety.

The heating apparatus may include a steam suction pump to suck steam from cooking/heating cavity between the container and the lid to ensure that extra steam is promptly removed out of the cooking/heating cavity before opening of the lid.

The heating apparatus may further include a grill configured with the base and configured to support the container from a rim of the container, thereby holding the container in a suspended position. The grill may be configured such that, by holding the container from the rim in suspended position, the grill ensures alignment of the rim of the container with the lid when the lid is lowered over the container.

Heating apparatus may further include image sensor and thermal sensors to detect the ingredients added to the container as well as to detect the food being cooked at optimal levels and prevent food from undercooking or overheating. Further these sensors can also detect smoke/steam from any burning that could arise in the cooking cavity.

The heating apparatus may include a weight sensor configured with the grill to detect presence of the container placed on the grill, as well as to detect how much ingredients by weight is added to the container.

The lid may be pivotally held with the base through a self-aligning hinge, which allows movement of the lid so that, in the lowered position of the lid, any tolerance or gaps between the lid and the container is accommodated to ensures the lid and the container are in contact and secure. The grill is configured such that, the pivotal axis of the lid coincides with the pivotal axis of the grill, to ensure that, when the lid is closed over the container placed over the grill, the lid and the container are parallelly aligned, thus ensuring the searing flat surface of container resting on the grill is parallel to the lid when the lid is in the lowered position.

The heating apparatus may further include one or more storage containers provided on the base for storage of one or more liquids for spraying the stored liquids in a cooking/heating cavity between the container and the lid.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary representation of an embodiment of the disclosed heating apparatus having a hinged lid pivotally fixed to a base, showing a container supported over an integrated grill, in accordance with embodiments of the present invention.

FIGS. 2A to 2C illustrate exemplary front perspective, back perspective and side views respectively of the disclosed heating apparatus of FIG. 1, in accordance with embodiments of the present invention.

FIG. 3 illustrates yet another exemplary representation of the heating apparatus of FIG. 1, showing choke, lid lock and plungers to detect proper closing of the lid over the container, in accordance with embodiments of the present invention.

FIG. 4 illustrates another exemplary representation of the heating apparatus of FIG. 1, showing self-aligning hinge that pivotally holds the lid and ensures alignment between the lid and the container, in accordance with embodiments of the present invention.

FIGS. 5A to 5C illustrate exemplary sectional views showing arrangement of the plungers on the lid to detect if the lid is properly closed over the container, in accordance with embodiments of the present invention.

FIGS. 6A and 6B illustrate exemplary sectional views showing working of the locking arrangement that locks the lid with the grill, in accordance with embodiments of the present invention.

FIGS. 7A and 7B illustrate an alternate embodiment of the grill for the apparatus of FIG. 1, in accordance with embodiments of the present invention.

FIG. 8 illustrates different valves provided on the lid, in accordance with embodiments of the present invention.

FIGS. 9A to 9C illustrate exemplary representation of an alternate embodiment of the disclosed heating apparatus having a lid retractably configured with a chimney, in accordance with embodiments of the present invention.

FIGS. 10A and 10B illustrate exemplary circuit diagrams indicative of the manner in which, in an instance, microwave leakage detection can be performed in accordance with embodiments of the present invention.

FIG. 11 illustrates an exemplary front perspective view of the disclosed heating apparatus with yet another embodiment of the grill, in accordance with embodiments of the present invention.

FIGS. 12A and 12B illustrate exemplary back perspective views of the disclosed heating apparatus with two magnetrons, storage containers and pump, in accordance with embodiments of the present invention.

FIG. 13 illustrates an exemplary front perspective view of the disclosed heating apparatus showing a stirrer configured with the lid, in accordance with embodiments of the present invention.

FIG. 14 illustrates an exemplary front perspective view of the disclosed heating apparatus showing an image sensor camera, means for spraying oil, water and steam, etc. configured with the lid, in accordance with embodiments of the present invention.

FIG. 15 illustrates an exemplary front perspective view of the disclosed heating apparatus showing weight sensors configured with the lid, in accordance with embodiments of the present invention.

FIG. 16A illustrates an exemplary front perspective view of the disclosed heating apparatus showing the grill being hinged such that pivot axis of the grill coincides with pivot axis of the lid, in accordance with embodiments of the present invention.

FIGS. 16B to 16E illustrate exemplary views of the disclosed heating apparatus showing details of an alternate embodiment of the locking mechanism for locking the lid, in accordance with embodiments of the present invention.

FIG. 17 illustrates an exemplary front perspective view of the disclosed heating apparatus showing details of choke and its locking, in accordance with embodiments of the present invention.

FIG. 18 illustrates an exemplary front perspective view of the disclosed heating apparatus showing use of a stirrer motor of the apparatus for other accessories like a Idli maker, in accordance with embodiments of the present invention.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms are used herein. To the extent a term used in a claim is not defined, it should be given the broadest definition persons in the pertinent art have given that term as reflected in printed publications and issued patents at the time of filing.

The present disclosure provides an improved heating apparatus for multiple modes of heating that allows microwave heating in combination with other modes of heating, such as open flame heating using gas burners, induction heating using an induction plate, heating using a hot plate, or any other similar traditional mode of heating. Conventional heating/cooking apparatuses for multiple modes of heating/cooking have drawback of in efficient use of microwaves generated by the magnetron attached to a lid of the apparatus that closes over a container when microwave heating is required. Since multiple modes of heating requires the container to be placed over a traditional source of heat, such as a gas burners or an induction plate or a hot plate, the top side of the container may not be in alignment with the lid as the lid closes over the container. This results in improper closing, i.e. gap between the lid and the container, which results in leakage of microwaves. Even a choke provided on the lid to prevent the leakage cannot work efficiently if the gap is more than a desired gap value.

In an embodiment, the heating apparatus of the present disclosure includes a cradle shaped grill, which is coupled to a base of the apparatus, and is adapted to hold the container from an upper rim of the container in a suspended condition keeping bottom of the container away from the surface of the traditional source of heat, thereby making the alignment of the container free from the traditional source of heat.

In an embodiment, the apparatus includes a sensing mechanism to sense proper closing of the lid over the container. Specifically, the sensing mechanism, which works based on a plurality of plungers configured on periphery of the lid, senses if gap between the lid and the rim of the container is more than a predefined gap value. Moreover, only if all the plungers travel at a uniform predefined gap, when the lid is closed, only then the switch is triggered. The sensing mechanism is coupled to a control circuit of the apparatus to deny putting the magnetron on unless the lid is properly closed.

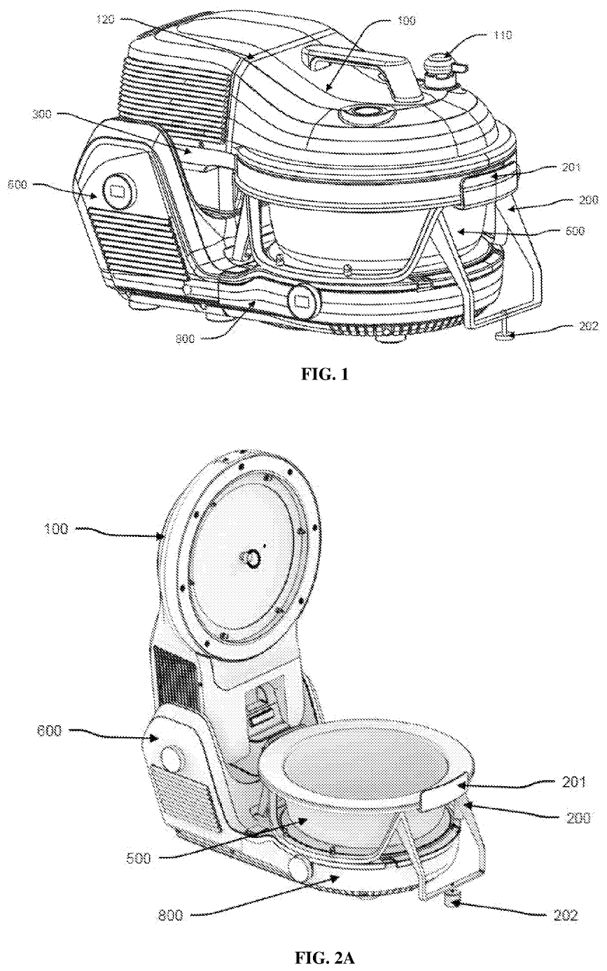

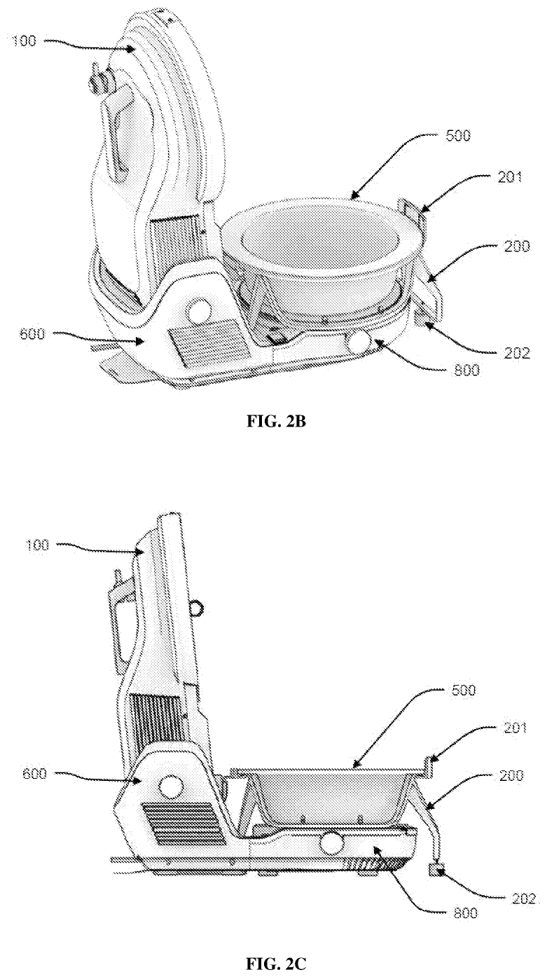

Referring now to FIGS. 1 and 2A to 2C where exemplary representations of the disclosed heating apparatus showing a container supported over an integrated grill are disclosed, the heating apparatus can include a base 800, a lid 100 pivotally fixed to a hinge housing pillar 600 that extend vertically up from the base 800. The pivotal coupling of the lid 100 to the hinge housing pillar 600 is through a self-aligning hinge 300 that allows the lid to tilt left side or right side, thereby providing a self-aligning functionality to the lid 100 in left-right direction. Further, a cradle shaped grill 200 is coupled to the hinge housing pillar 600, which is configured to hold a container 500 from an upper rim of the container 500 in suspended condition, without bottom of the container 500 resting on the base 800. The container includes an inner cavity 503 within the upper rim, being configured to hold food items being cooked.

The lid 100 includes a split part 120 to prevent heat transfer-from the lid 100 to back side that houses a magnetron, and one or more valves, such as an adjustable pressure weight valve 110 shown in FIG. 1. FIG. 8 shows further details of the one or more valves provided with the lid 100. The one or more valves further include a secondary pressure safety valve 115 and a metal safety plug (MSP) fusible safety plug 116. The adjustable pressure weight valve 110 can include a high pressure setting 112, a low pressure setting 111 and a quick steam release position 113.

Reverting back to FIGS. 1 and 2A to 2C, which show one embodiment of the grill 200 having a proximally located leg and an adjustable grommet 202 provided al lower end of the proximally located leg of the grill 200. The adjustable grommet 202 can be used to lift or lower the proximal side of the grill 200 and the container 500 located thereon to tilt the container 500 in a front-rear direction.

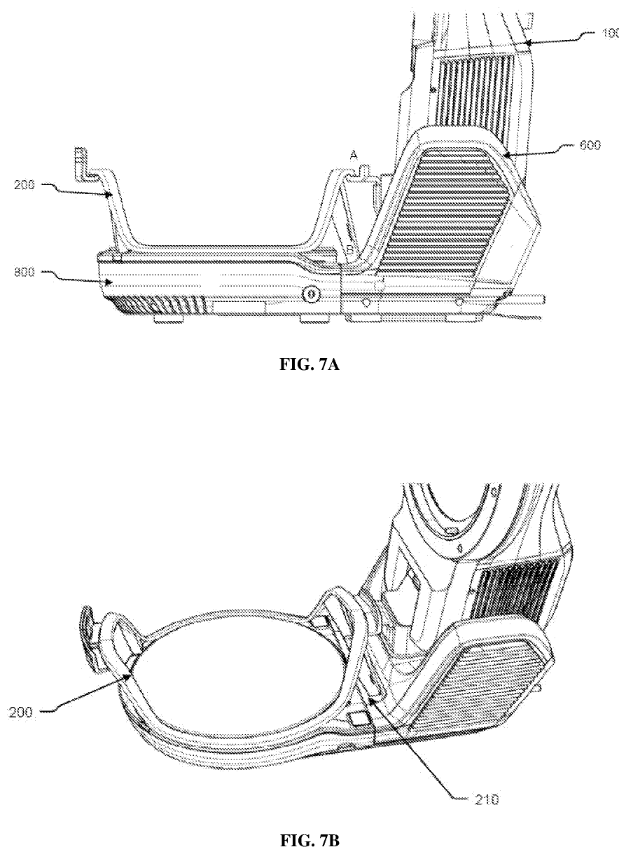

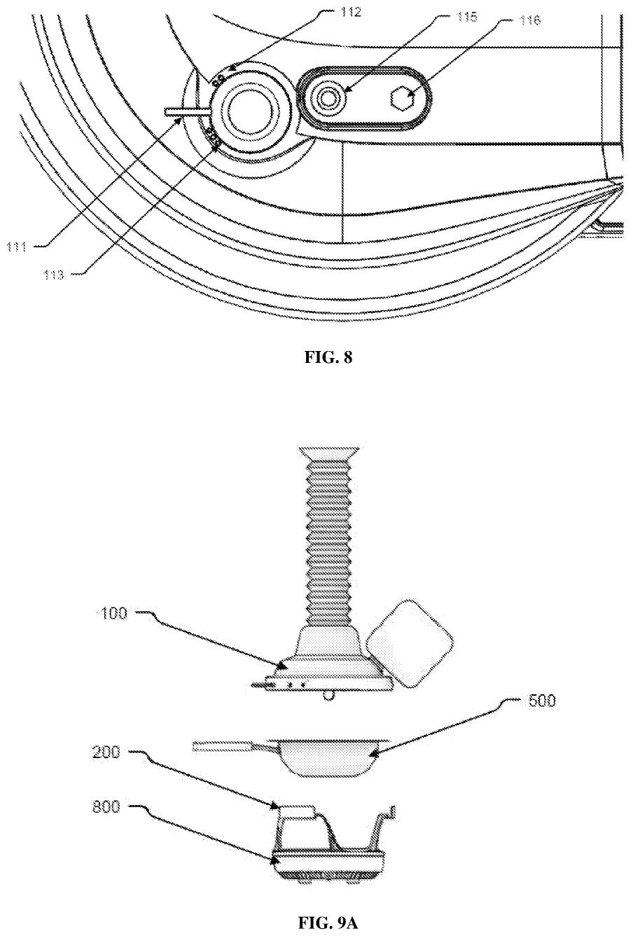

FIGS. 7A and 7B show an alternate embodiment of the grill 200 that does not require the adjustable grommet 202 at front end of the grill 100. The grill includes a distally located leg that provides a back support at point B, in addition to coupling point A, as shown in FIG. 7A, to securely support the grill 200 with a top surface of the grill in alignment with the closed lid 100 so that container 500 kept thereon is parallel to the lid 100 when closed over the container 500.

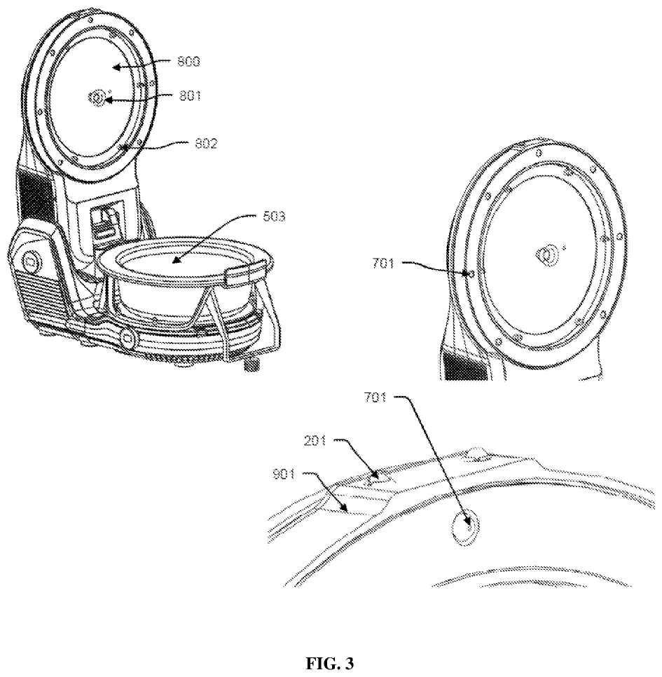

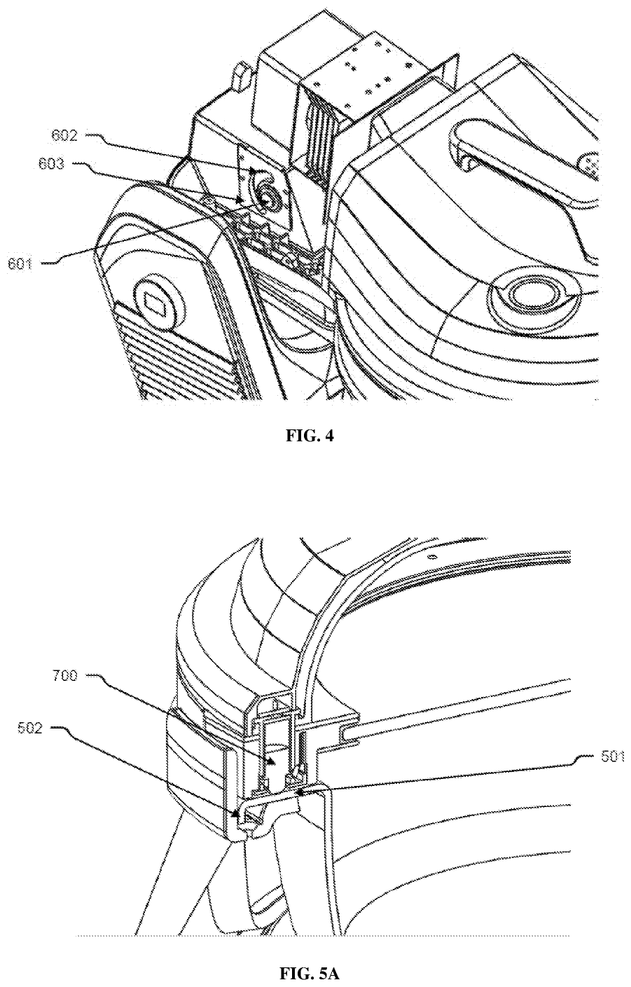

FIG. 3 illustrates yet another exemplary representation of the heating apparatus showing choke 901 configured with an inner peripheral surface of the lid 100, a lid lock comprising ball catch locking 201, and a plurality of electrically connected plungers 701 provided on periphery of the lid 100 such that when the lid 100 is closed over the container 500 the plungers 701 make contact with the rim of the container 500 if the gap between the lid 100 and the container 500, at the location of the respective plunger 701, is less than a predefined gap. The predefined gap can correspond to a gap that should not be exceeded for proper functioning of the choke 901 for efficient prevention of leakage of the microwaves. A proper closing is detected when all the plungers 701 are in contact with the rim of the container 500. The lid further includes a removable glass 800 fixed on an inner side of the lid 100 bt thumb screws 802. A glass handle 801 is provide at center of the removable glass 800 to hold the glass 800 when being removed.

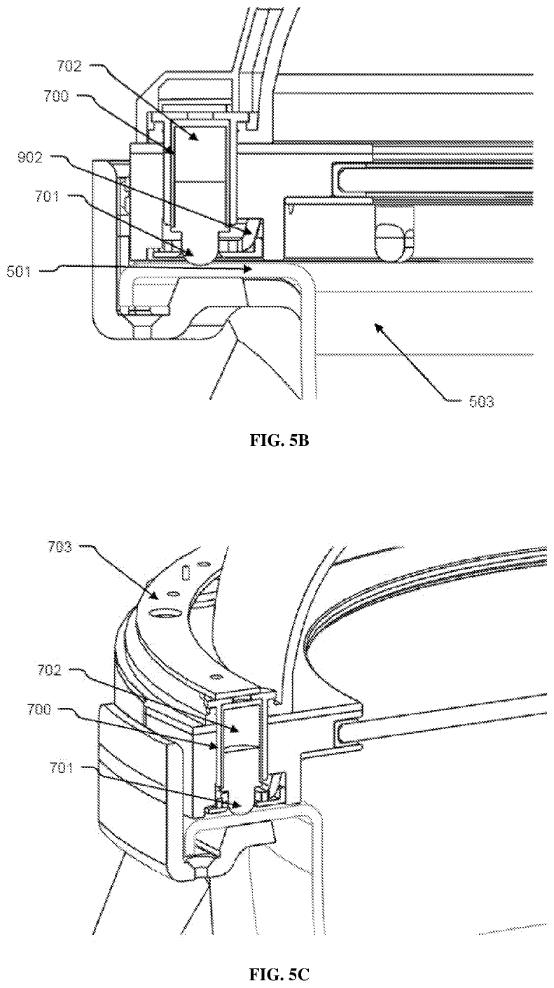

FIG. 4 illustrates another exemplary representation of the heating apparatus showing self-aligning hinge that pivotally holds the lid and ensures alignment between the lid and the container. The self-aligning hinge includes a set of self-aligning bearings 601, a set of guide pin 602 and a set of guides 603 configured on either side of the hinge housing pillar 600. The self-aligning hinge allows movement such that any tolerance or gaps can be accommodated easily and ensures the lid 100 and the container 500 are in contact with each other and secure. Thus, the self-align hinge 300 in combination with the adjustable grommet 202 allows leveling of the flat top surface 501 (refer FIGS. 5A to 5C) of rim of the container 500 to align with the lid 100 to ensure proper seating of the lid 100 over the container 500.

FIGS. 5A to 5C illustrate exemplary sectional views showing details of the plunger assemblies on the lid 100 to detect if the lid 100 is properly closed over the container 500. Each plunger assembly 700 can include a plunger 702 backed by a nylon sleeve 702 that biases the plunger 701 in outward direction but allow the plunger 701 to move inward when pushed in that direction. The plungers 701 can project out by a length such that, when the lid 100 is closed over the container 500, the plunger 701 makes a contact with a top flat surface 501 of the rim of the container 500 only when the gap between the lid 100 and the top flat surface 501 of the container 500 is less than the predefined gap. A PCB 703 is provided in the lid 100 and the plungers are electrically connected to the PCB 703. The electrically connected plungers 701 are configured such that connection is completed only when the plungers 701 make contact with the container 500. Thus, if the gap between the lid 100 and the container 500 is more that the predefined gap, an indication is received that the lid is not properly closed having more gap than desired. Thus, the proper closing of the lid 100 is sensed and can be linked to control circuit of the apparatus that controls operation of the magnetron.

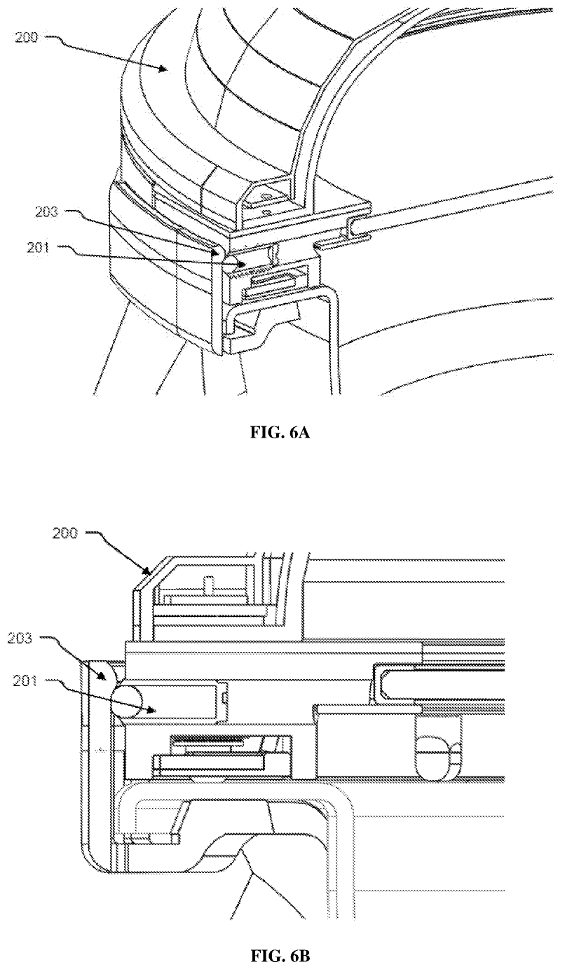

FIGS. 6A and 6B illustrate exemplary sectional views showing working of the locking arrangement that locks the lid 100 with the grill 200. The locking arrangement comprises ball catch lock 201 that engages with a protuberance on a locking surface 203 of the grill 200, when the lid 100 is closed over the container 500. This sandwiches the rim of the container 500 between the lid 100 and the grill 200.

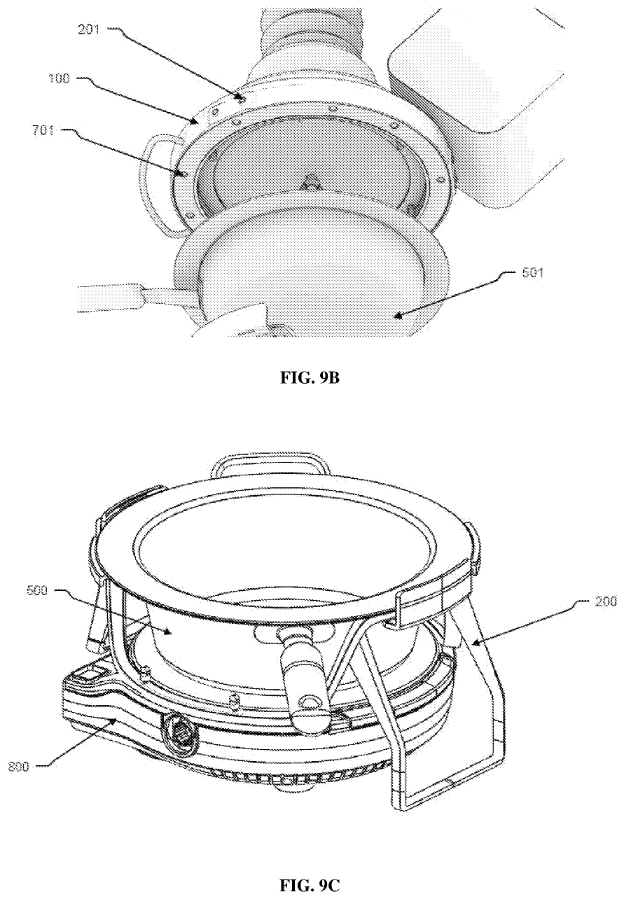

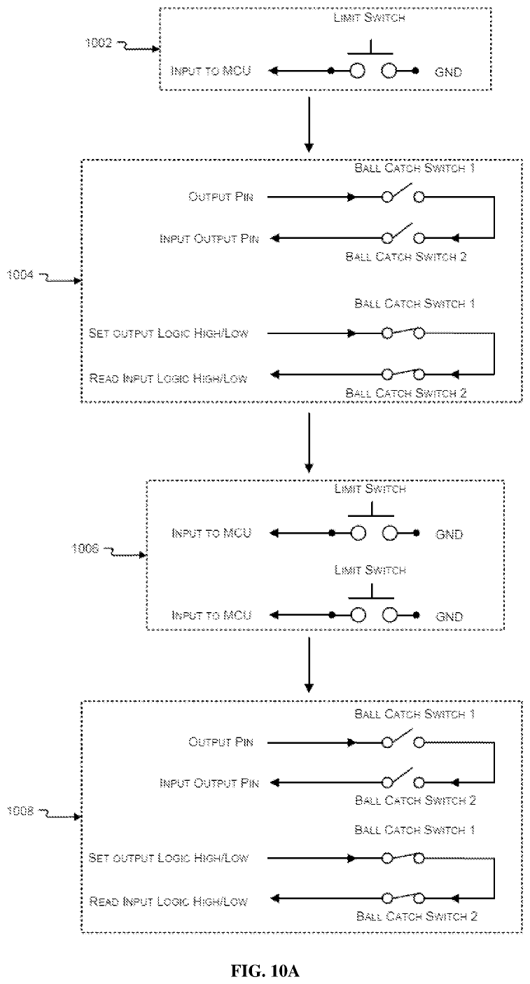

FIGS. 9A to 9C shows a second embodiment of the disclosed heating apparatus having a lid retractably configured with a chimney. As shown, the lid comprises sensing mechanism to sense proper closing of the lid 200 over the container 500, as well as a grill 200 configured with the base 800. Additionally, a locking arrangement is provided on the lid 100 that locks the lid 100 with the grill 200 sandwiching the rim of the container 500 in between. The locking arrangement can be any mechanical locking arrangement. The locking arrangement can be based on ball catch lock 201 that engages with a protuberance on a locking surface 203 of the grill 200, as shown in FIGS. 6A and 6B, However, other types of locking arrangements are well within the scope of the present disclosure.

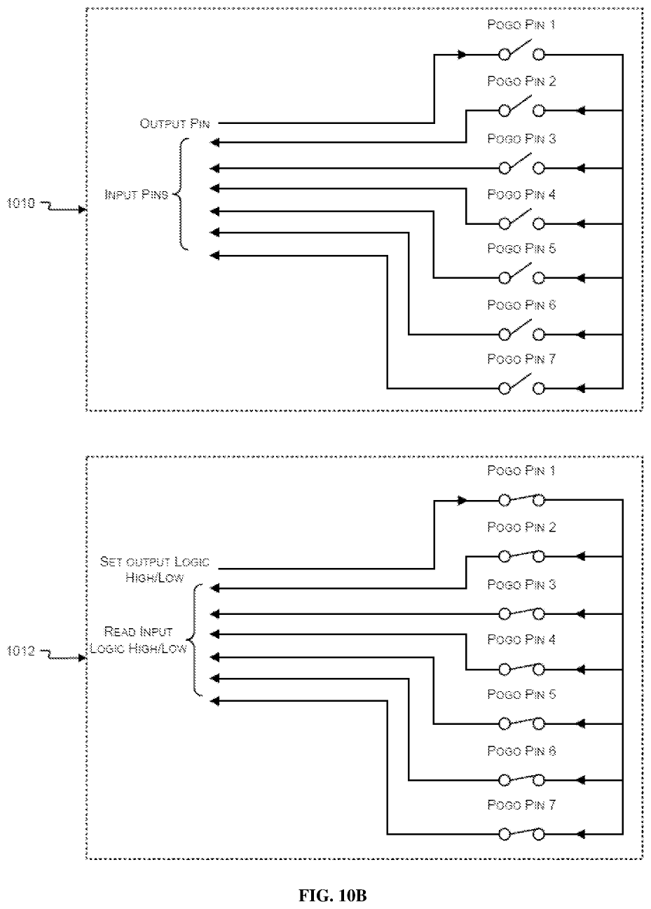

FIGS. 10A and 10B illustrate exemplary circuit diagrams indicative of the manner in which, in an instance, microwave leakage detection can be performed in accordance with embodiments of the present invention. In an aspect of the present disclosure, circuitry of the present disclosure can be configured to check/detect when the device power is put ON and check fault if any in the overall device or a part thereof. Exemplary circuit 1002 can enable detection of whether the grill is correctly placed (which if not, can enable generation of an error code for resolution). Similarly, exemplary circuit 1004 can enable detection of whether the pan is correctly placed (which if not, can enable generation of an error code for resolution). Once it has been determined that the grill and/or pan are correctly placed, initial instructions to start the magnetron can be transmitted, post which, through the exemplary circuit 1006, it can be checked as to whether the AC Limit Switch for the lid is closed (which if not, can enable generation of an error code for resolution). Exemplary circuit 1008 can assist in detecting if the DC Limit Switch for the lid is closed (which if not, can enable generation of an error code for resolution). Exemplary circuit 1010 can subsequently assist in confirming whether the pan is locked (which if not, can enable generation of an error code for resolution). Finally, exemplary circuit 1012 can subsequently check if the lid is completely flat on the pan (which if not, can enable generation of an error code for resolution). Once all the tests from 1002 to 1012 are confirmed, it can be confirmed that no microwave leakage is detected and the magnetron can actually be started accordingly.

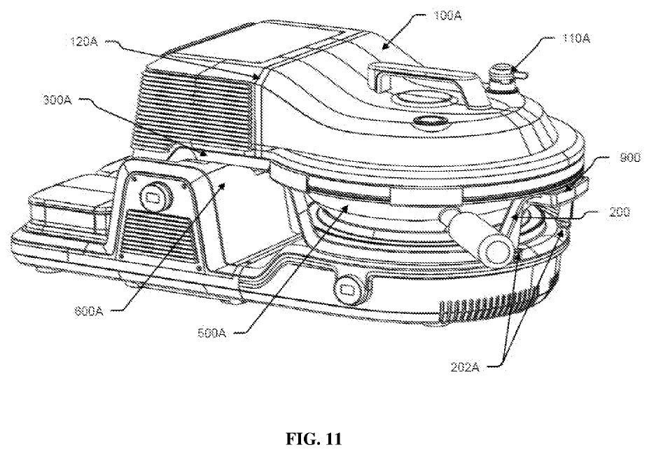

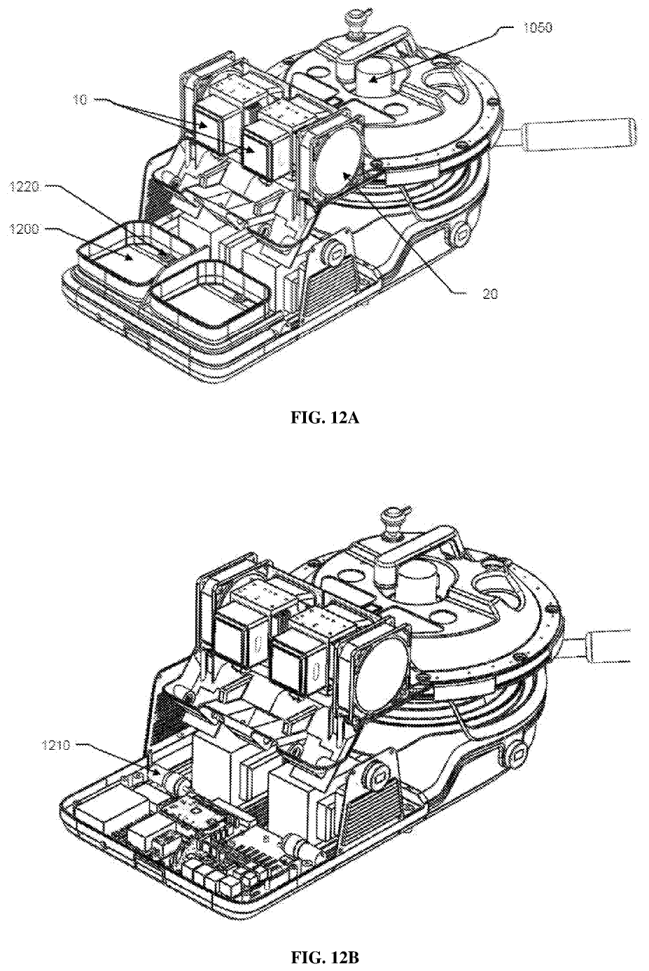

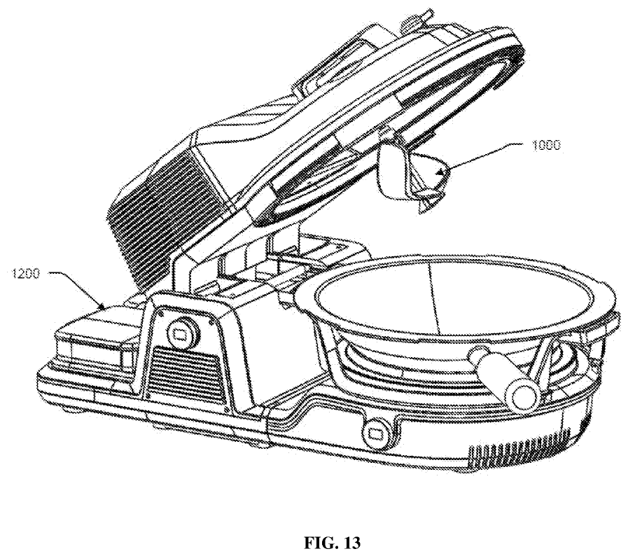

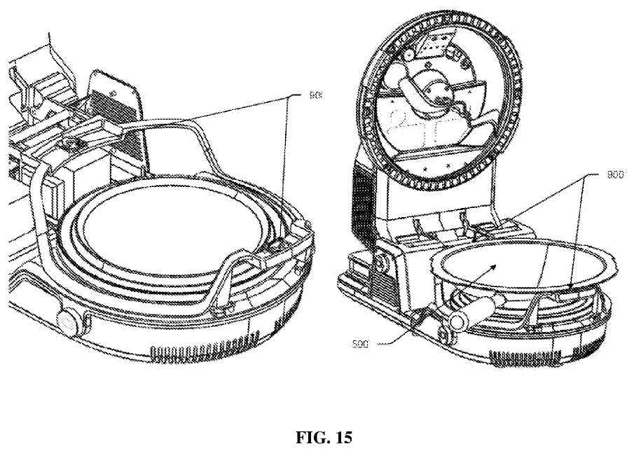

Referring to FIG. 11 where yet another embodiment of the grill is shown, as shown the grill 200 can rest on the base through adjustable grommets 202A configured on a proximal side of the grill 200, i.e., the side that is opposite the hinge housing 600A that house the self-aligning hinge 300A. Also shown therein are the split part 120A to prevent heat transfer from the top lid 100A to back side that houses the magnetron 10 (refer to FIGS. 12A and 12B), and weight sensors/load cells 900 provided on an upper side of the grill 200 to sense weight of the container/pan 500 thereby detecting the pan placed thereon, which are further described against FIG. 15.

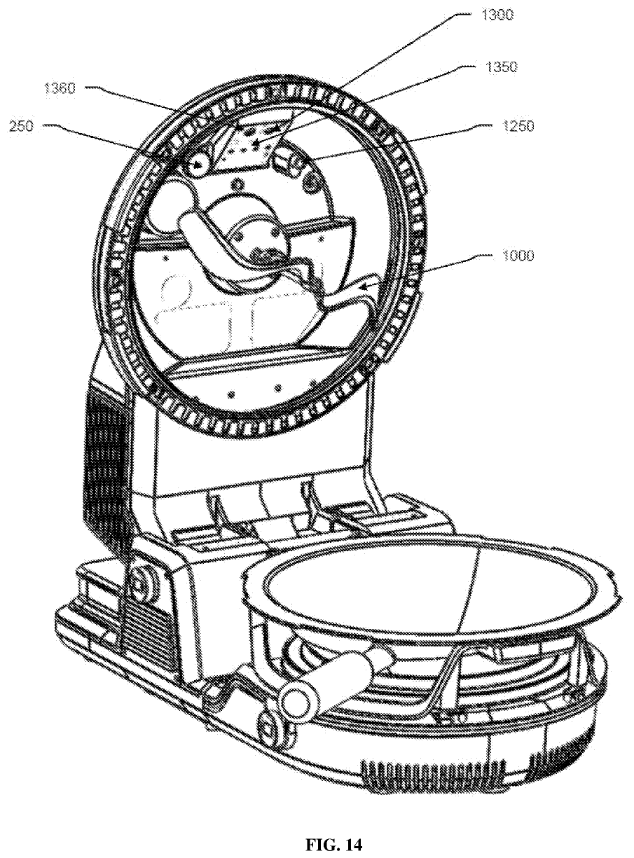

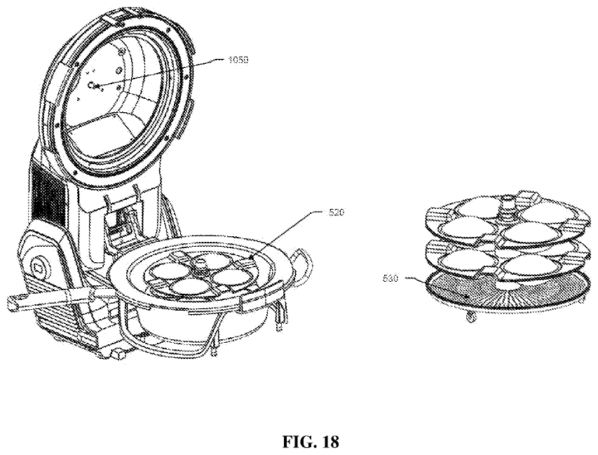

FIGS. 12A and 12B show interior view of back side of the lid and the base showing installation of two magnetrons 10, cooling fans 20 to cool the magnetrons 10 on a back side of the lid 100A beyond the split part 120A. Also shown are storage containers 1200 and pumps 1210 to store and pump liquids required during cooking, such as but not limited to water and oil, through valves 1220. The pumps 1210 help to pump water and oil from the containers 1200 to sprayers 1250 (refer to FIG. 14) for adding to item being cooked to ensure that the food doesn't dry up while cooking. Also shown in FIG. 12A is a motor 1050 coupled to the lid 100A for rotating a stirrer 1000 (refer to FIG. 13) or rotating other accessories 520, such as an Idli maker placed on a ceramic base with wheels 530 (refer to FIG. 18).

FIG. 13 shows the stirrer 100 configured with the lid 100A such that, when the lid is closed over the container/pan 500, rotation of the stirrer 100 by the motor 1050 causes the food contained in the container 500 to be stirred/mixed. Stirrer 100 may be customized to profile of the inner cavity 503 of the container 500. The stirrer 1000 can also be configured to distribute the microwaves inside the microwave cavity as well as the contents inside the pan such as food or accessories, etc.

FIG. 14 shows arrangement of an image sensor camera 1360, far infrared thermal sensor camera 1300, steam suction 1250, the sprayer 1250 for spraying oil, water etc., LED light 1350, and the stirrer 1000 configured with the lid 100A. Functionality of steam suction via a steam suction pump is provided to ensure that the extra steam can be promptly evacuated/sucked out of the cooking/heating cavity, such as before opening of the lid 100A. Under normal conditions, the steam would be released through the adjustable pressure weight valve 110A (refer to FIG. 11), however, having an instant suction for steam saves time and ensures the steam does not condense to water and fall back into the items being heated/cooked.

The image sensor camera 1360 and the infrared thermal sensors camera 1300 are provided to enable viewing of food while being heated/cooked. This ensures a completely optimised and automated heating/cooking solution, whereby the primary heating from microwaves and secondary heating, such as by induction, or by flame from a flame stove, or infrared, or resistance coils etc., is controlled to ensure that the food doesn't overheat/undercook.

FIG. 15 illustrates an exemplary front perspective view of the disclosed heating apparatus showing weight sensors 900 configured with the lid, in accordance with embodiments of the present invention. The weight sensors 900 are placed in the grill 200 for dual functionality. It can detect presence of container 500 placed on the grill 200, as well as it can detect how much ingredients by weight is being added. Weight of ingredients measured by the weight sensor 900 can help in cooking in conjunction with an app or built-in recipe.

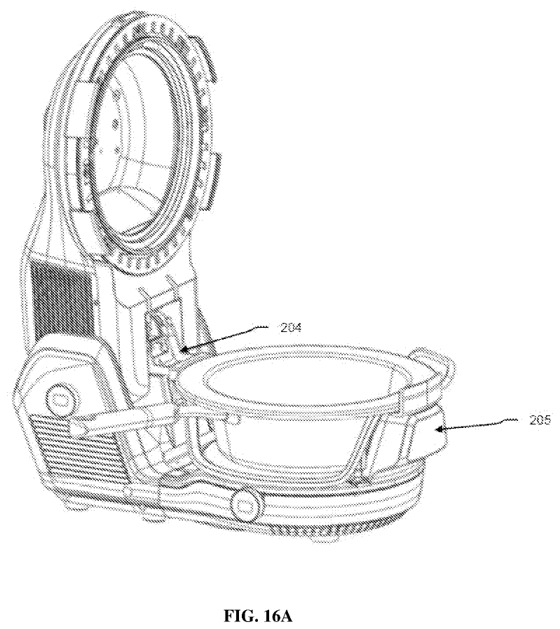

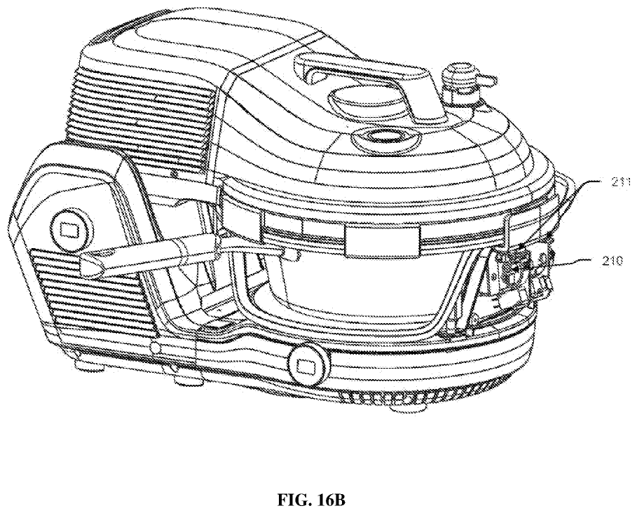

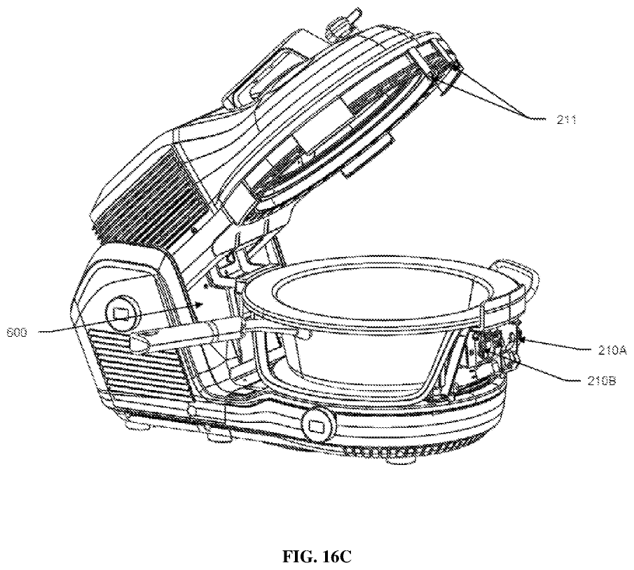

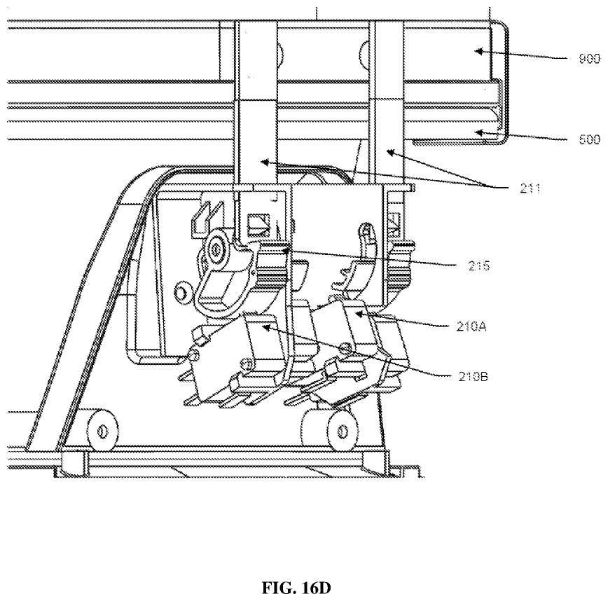

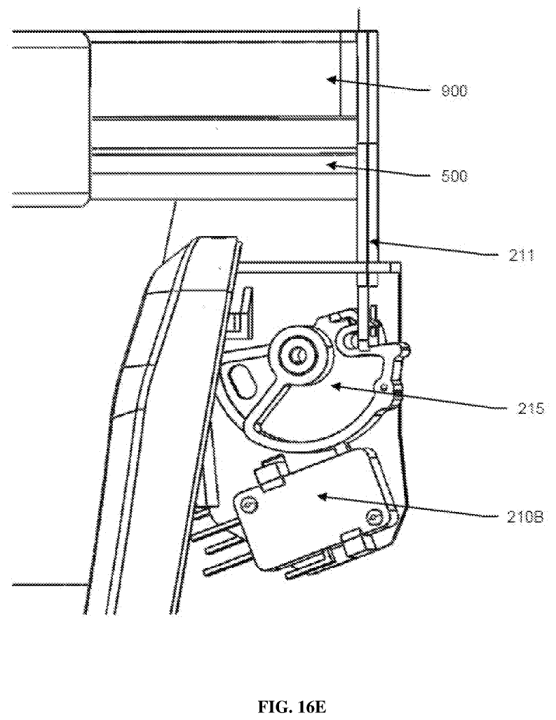

FIG. 16A shows an embodiment of the grill that is hinged at a grill hinge 204. The grill hinge 204 is configured such that the pivotal axis of the grill 200 coincides with the pivotal axis of the lid 100A. This ensures that, when the lid 100A is closed over the container 500 placed over the grill, they are parallelly aligned, thus ensuring the seating flat surface of container resting on the grill is parallel to the lid when the lid is in the lowered position.

FIGS. 16B to 16E show details of an alternate embodiment of the locking mechanism for locking the lid 100A. The locking mechanism includes a pair of locking guide pins 211 and a pair of locking sensor switches 210A and 210B (collectively locking sensor switches 210). The locking guide pins 211 may be configured with the lid 100A to move along with the lid 100A when the lid is closed over the container 500 and engage with corresponding locking mechanisms 215 that are housed in the grill 200. As the locking guide pins 211 engage with the corresponding locking mechanisms 215 they also actuate the corresponding locking sensor switches 210 located close to the locking mechanisms 215 on the grill 200. These switches work in conjunction with a monitor switch 210C configured with the spring loaded pogo pins 700 for pan detection. Electric circuit to switch on the magnetrons 10 may be configured such that if any one of the three switches 210A, 210B and 210C, does not get actuated, the magnetron will not switch ON. This is for safety of the apparatus and to ensure microwaves are emitted only when the container/pan 500 is present and the lid 100A is closed completely and locking pins and sensor switches are engaged.

In an aspect, the locking guide pins 211 being configured to engage with locking mechanisms 215 and actuate the locking sensor switches 210A and 210B that are concealed, such as in a lock housing 205, shown in FIG. 16A, so that the locking sensor switches 210A and 210B are not accessible from outside, meets the regulatory certification requirements related to safety of operation of the microwave-based heating apparatuses.

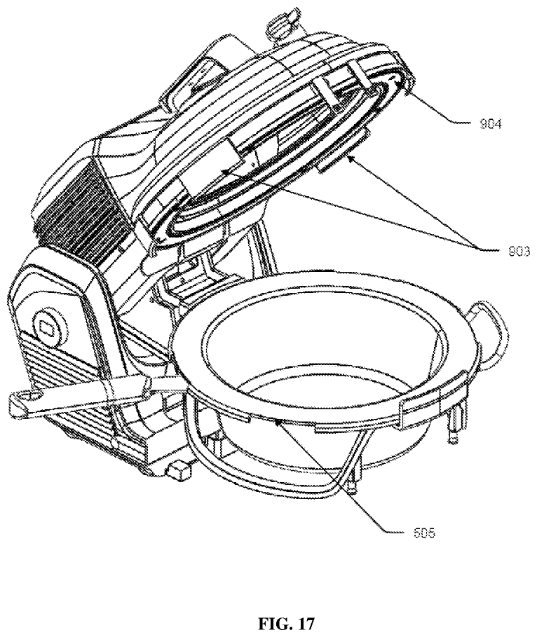

FIG. 17 shows details of choke mechanism (also referred simply as choke) and its locking that prevent microwave leakage. In an aspect, the choke mechanism 901 is designed such that the lid 100A fits tightly over the container 500 so as to build pressure for cooking. The choke 901 includes metallic choke fingers 902 (refer FIG. 5B), a choke gasket 904 and choke locking members 903. Cuts 505 are provided on the container 500 to ensure that the choke locks with the container 500 thereby creating the required pressure for pressure cooking. In alternate embodiments the cuts 505 may be replaced by protrusion that project up to engage with the lid 100A.

The adjustable pressure weight valve 110/110A is provided for steam release in combination with the secondary pressure safety valve 115 and a metal safety plug (MSP) fusible safety plug 116 (refer to FIG. 8) to ensure safety.

It is to be appreciated that while the choke mechanism that is configured to lock with the container to enable pressure cooking has been described with reference to a lid that is hinged to the base of the apparatus, it is possible to provide a similar choke mechanism with the apparatus having a lid that is configured with a chimney, as shown in FIGS. 9A to 9C, and all such applications are well within the scope of the present application.

FIG. 18 shows use of a stirrer motor 1050 of the heating apparatus for other accessories 520. For this, an output shaft of the motor 1050 can be configured such that, when required, the stirrer 1000 can be removed and, when the lid 100A is closed over the container 500, the output shaft of the stirrer motor 1050 couples with the accessory 520 placed within the container 500 to rotate the accessory to ensure that the food item placed on the accessory is exposed to the microwaves evenly. The accessories 520 can be, but not limited to, a cake molds, idli maker, Pizza, roti, microwave safe containers for reheating food, etc. The accessories 520 may be placed over a ceramic plate 530 with wheels to work as a turn table.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides an improved heating apparatus that over comes drawback of the conventional apparatuses for multiple modes of heating.

The present disclosure provides a heating apparatus with a lid configured to align with a top surface of a rim of the container to ensure proper closing of the lid over the container.

The present disclosure provides a heating apparatus that aligns the container with the lid irrespective of level of the surface of the traditional source of heat.

The present disclosure provides a heating apparatus that does not allow the magnetron to get on unless the lid is properly closed over the container.

The present disclosure provides a heating apparatus that includes a sensing mechanism to sense that gap between the lid and the rim of the container.

The present disclosure provides a heating apparatus that includes a locking mechanism to lock the lid over the container.

The present disclosure provides a microwave-based heating apparatus that allows pressure cooking.

The present disclosure provides a heating apparatus that allows App based cooking.

The present disclosure provides a heating apparatus that allows spraying of liquids, such as oil and water in the cooking cavity.

The present disclosure provides a heating apparatus that allows prompt evacuation/sucking of steam from the cooking cavity before opening of the lid,

The present disclosure provides a microwave-based heating apparatus that meets the prevailing certification requirements related to safety of operation of the apparatus.

I claim:

1. A heating apparatus comprising:
a lid configured for movement between a raised position and a lowered position, wherein in the lowered position the lid is configured to cover a container containing items to be heated or cooked; and
at least one microwave generating device coupled with the lid as a source of microwaves, such that in the lowered position of the lid, the heating apparatus enables microwave heating using the at least one microwave generating device in combination with any of: application of heat to the container from bottom using another heat source and a preparatory operation on contents of the container.
wherein the lid comprises a sensing mechanism to sense proper closing of the container by the lid to ensure that microwaves generated by the at least one microwave generating device do not leak out.

2. The heating apparatus of claim 1, wherein the sensing mechanism comprises a plurality of retractable plungers provided on periphery of the lid, the plungers being biased outward and configured to linearly move inward on coming in contact with a seating surface of the container as the lid is closed over the container; wherein the plungers are configured such that contact with the seating surface of the container takes place if a gap between the lid and the seating surface of the container is less than a predefined gap value; and wherein the plungers are electrically connected such that the connection is completed when the plungers make contact with the container, and wherein the completion of the connection is used as a confirmation that the lid is properly closed over the container.

3. The heating apparatus of claim 2, wherein the heating apparatus comprises:
a weight sensor configured to detect presence of the container, as well as to detect how much ingredients by weight is added to the container; and
a locking mechanism to lock the lid after it is closed over the container; the locking mechanism comprising two or more locking sensor switches that are located in a concealed location.

4. The heating apparatus of claim 4, wherein the heating apparatus comprises a control circuit, the control circuit being configured to switch the microwave generating device ON only after the connection of the plungers is completed, receipt of a signal from the weight sensors indicative of presence of the container and receipt of a signal from the locking sensors confirming locking of the lid.

5. The heating apparatus of claim 5, wherein the heating apparatus comprises a choke mechanism to avoid leakage of microwaves, and wherein the predefined gap value relates to maximum gap allowed between the lid and the seating surface of the container for efficient functioning of the choke.

6. The heating apparatus of claim 1, wherein the lid is pivotally configured with a base for pivotal movement between the raised position and the lowered position; and wherein the base includes a conventional source of heat and the container is positioned to receive heat from the conventional source of heat in addition to heating by microwaves generated by the at least one microwave generating device.

7. The heating apparatus of claim 7, wherein the heating apparatus further comprises a grill configured with the base, the grill being configured to support a container from a rim of the container holding the container in a suspended position, and wherein the grill is configured such that, by holding the container from the rim in suspended position, the grill ensures alignment of the rim of the container with the lid when the lid is lowered over the container; and wherein the weight sensors and the two or more locking sensor switches are located on the grill in a concealed location.

8. The heating apparatus of claim 1, wherein the lid is configured with a chimney by a lifting and lowering mechanism for vertical movement between the raised position and the lowered position; and wherein the container is any one of a first container placed over a conventional source of heat, and a second container for preparatory operations comprising any or a combination of blending, stirring, grinding and mixing; and wherein coupling of the lid with the containers enables heating of the contents of the container through the microwaves generated by the at least one microwave producing device.

9. A heating apparatus comprising:
a base;
a grill configured with the base, the grill being configured to support a container from a rim of the container holding the container in a suspended position;
a lid configured for movement between a raised position and a lowered position, wherein in the lowered position the lid covers the container; and
at least one microwave generating device coupled with the lid as a source of microwaves, such that in the lowered position of the lid, the heating apparatus enables microwave heating using the at least one microwave generating device, and wherein the heating apparatus also allows application of heat to the container from bottom using any or a combination of induction, open flame, radiation, convection, and conduction heat source;
wherein the grill is configured such that, by holding the container from the rim in suspended position, the grill ensures alignment of the rim of the container with the lid when the lid is lowered over the container.

10. The heating apparatus of claim 9, wherein the lid is pivotally held with the base through a self-aligning hinge, which allows movement of the lid so that, in the lowered position of the lid, any tolerance or gaps between the lid and the container is accommodated to ensures the lid and the container are in contact and secure.

11. The heating apparatus of claim 9, wherein the lid comprises a plurality of retractable plungers provided on periphery of the lid, the plungers being biased outward and configured to linearly move inward on coming in contact with a seating surface of the container as the lid is closed over the container; wherein the plungers are configured such that contact with the seating surface of the container takes place if a gap between the lid and the seating surface of the container is less than a predefined gap value; and wherein the plungers are electrically connected such that the connection is completed when the plungers make contact with the container, and wherein the completion of the connection is used as a confirmation that the lid is properly seated over the container.

12. The heating apparatus of claim 11, wherein the heating apparatus comprises:
a weight sensor configured with the grill to detect presence of the container placed on the grill, as well as to detect how much ingredients by weight is added to the container; and
a locking mechanism to lock the lid after it is closed over the container; the locking mechanism comprising two or more locking sensor switches that are located on the grill in a concealed location.

13. The heating apparatus of claim 12, wherein the heating apparatus comprises a control circuit, the control circuit being configured to switch the at least one microwave generating device on only after completion of the connection of the plungers, receipt of a signal from the weight sensors indicative of presence of the container and receipt of a signal from the locking sensors confirming locking of the lid.

14. The heating apparatus of claim 11, wherein the heating apparatus comprises a choke mechanism to avoid leakage of microwaves, and wherein the predefined gap value relates to maximum gap allowed between the lid and the rim of the container for efficient functioning of the choke.

15. The heating apparatus of claim 9, wherein the base provides a heat source to enable any or a combination of induction, open flame, radiation, convection, and conduction heating.

16. The heating apparatus of claim 10, wherein the grill comprises an adjustable grommet configured at a lower end of a front leg, wherein the adjustable grommet is configured for an upward and downward adjustment to align the container held in the grill with the lid.

17. The heating apparatus of claim 10, wherein the grill comprises a rear leg configured to rest on the base, the rear leg configured to ensure alignment of the container held in the grill with the lid.

18. A heating apparatus comprising:
a lid configured for movement between a raised position and a lowered position, wherein in the lowered position the lid is configured to cover a container containing items to be heated or cooked; and
at least one microwave generating device coupled with the lid as a source of microwaves, such that in the lowered position of the lid, the heating apparatus enables microwave heating using the at least one microwave generating device; and
a choke mechanism configured with the lid to avoid leakage of microwaves when the lid is lowered to cover the container;
wherein the choke mechanism is configured to allow the lid to fit tightly over the container so as to build pressure for pressure cooking.

19. The heating apparatus of claim 18, wherein the choke mechanism includes metallic choke fingers, a choke gasket and choke locking members that engage with the container to allow the lid to fit tightly over the container.

20. The heating apparatus of claim 18, wherein the heating apparatus comprises an adjustable pressure weight valve configured over the lid to allow steam release, a secondary pressure safety valve and a fusible safety plug to ensure safety.

21. The heating apparatus of claim 18, wherein the heating apparatus comprises a steam suction pump to suck steam from cooking/heating cavity between the container and the lid to ensure that extra steam is promptly sucked out of the cooking/heating cavity before opening of the lid.

22. The heating apparatus of claim 18, wherein the heating apparatus further comprises a grill configured with the base, the grill being configured to support the container from a rim of the container, thereby holding the container in a suspended position, and wherein the grill is configured such that, by holding the container from the rim in suspended position, the grill ensures alignment of the rim of the container with the lid when the lid is lowered over the container.

23. The heating apparatus of claim 18, wherein the heating apparatus comprises one or more storage containers provided on the base for storage of one or more liquids for spraying the stored liquids in a cooking/heating cavity between the container and the lid.
